(19) United States
(12) Patent Application Publication
(10) Pub. No.: US 2018/0135525 A1
(43) Pub. Date: May 17, 2018

(54) GAS TURBINE ENGINE TANGENTIAL ORIFICE BLEED CONFIGURATION

(71) Applicant: PRATT & WHITNEY CANADA CORP., Longueuil (CA)

(72) Inventors: Keith MORGAN, Westmount (CA); Ghislain PLANTE, Verdun (CA); Eric S. DUROCHER, Vercheres (CA); Kevin NG, Hamilton (CA); Johnny VINSKI, Chateauguay (CA)

(21) Appl. No.: 15/350,837

(22) Filed: Nov. 14, 2016

(51) Int. Cl. F02C 9/18; F04D 29/32; F04D 29/52

(52) U.S. Cl. CPC F02C 9/18; F04D 29/321; F05D 2270/301; F05D 2220/32; F04D 29/522

(57) ABSTRACT

A method of bleeding air from a gas turbine engine having a compressor section with a downstream centrifugal compressor is described, which includes bleeding air from a first location upstream of the centrifugal compressor's outlet, when the compressor is operating in a first pressure range, and bleeding air from a second location upstream of the centrifugal compressor's outlet, when the engine is operating in a second pressure range.

### TECHNICAL FIELD

The application relates generally to gas turbine engines and, more particularly, to bleed air configuration for engines with a centrifugal compressor.

### BACKGROUND

In an aircraft, bleed air is compressed air that is taken/bled from the compressor section of an engine. Bleed air is used to provide pressurized air to various parts of an aircraft, such as the environmental control system (hereinafter referred to as “ECS”).

In gas turbine engines where the last (most downstream) compression stage is a centrifugal compressor/impeller (hereinafter referred to as “Engines with a Downstream Centrifugal Impeller”), it is well known to take ECS bleed air from 2 locations along the engines' annular gas path: one at a (1^{st}) location positioned upstream of the last compression stage of the compressor (i.e. upstream of the centrifugal impeller), and another at a (2^{nd}) location positioned downstream of the centrifugal impeller and upstream of the combustor, at a location known as P3. Typically, when the engines are operating in a low pressure (Low Power) range environment (i.e. when operating at low thrust or at high altitude), Low Power ECS bleed air is taken at the 2^{nd} location (P3), and when the engines are operating in a high pressure (High Power) range environment (i.e. when operating at higher thrust or at lower altitude), High Power ECS bleed air is taken at the 1^{st} location. A switching valve, operating on detected pressure, normally ensures the alternation between the two (Low Power & High Power) ECS bleed sources.

There is an ongoing need for ever more efficient ECS bleed air configurations for gas turbine engines, more specifically for Engines with a Downstream Centrifugal Impeller.

### SUMMARY

In one aspect, there is provided a method of bleeding air from a gas turbine engine having a compressor section with a downstream centrifugal compressor, the method comprising, when the compressor is operating in a first pressure range, bleeding air from a first location positioned upstream of the centrifugal compressor's outlet; and, when the engine is operating in a second pressure range, the second pressure range being lower than the first pressure range, bleeding air from a second location positioned upstream of the centrifugal compressor's outlet, the second location being positioned downstream of the first location. The method may supply air to an ECS of an aircraft.

In another aspect, there is provided a compressor section of a gas turbine engine for providing compressed air to a combustor, the compressor section comprising: an annular gas path, positioned around the engine's centerline, for conveying air across the compressor section; a centrifugal impeller, positioned in the compressor section's downstream extremity, the centrifugal impeller comprising a plurality of blades protruding within the annular gas path, wherein air enters the centrifugal impeller in a generally axial direction and exits the centrifugal impeller in a generally radial direction; a centrifugal impeller shroud surrounding the blades and acting as a portion of the annular gas path's radially outer boundary; a first bleed opening arrangement, for bleeding air from the annular gas path when the engine is operating in a first pressure range; and a second bleed opening arrangement, positioned in the impeller shroud, for bleeding air from the annular gas path when the engine is operating in a second pressure range, the second pressure range being lower than the first pressure range. When in operation, the first and second bleed opening arrangements may provide bleed air to an ECS of an aircraft.

In a further aspect, there is provided a centrifugal compressor shroud for use in a compressor section of a gas turbine engine, the centrifugal compressor shroud comprising an ECS (ECS) bleed opening arrangement, for providing bleed air to an ECS, the ECS bleed opening arrangement comprising orifices aligned partially tangential to the anticipated compressed air flow direction.

Further details of these and other aspects of the subject matter of this application will be apparent from the detailed description and drawings included below.

### BRIEF DESCRIPTION OF THE DRAWINGS

Reference is now made to the accompanying figures in which:

FIG. 1 is a schematic cross-sectional view of a gas turbine engine;

FIG. 2 is a cross-sectional view of a compression section of an engine pursuant to an embodiment of the invention,

FIG. 3 is an isometric view of a centrifugal impeller pursuant to an embodiment of the invention;

FIG. 4 is a cross-sectional view of a centrifugal impeller pursuant to an embodiment of the invention; and

FIG. 5 is a cross-sectional view of a compression section of an engine pursuant to an alternate embodiment of the invention.

### DETAILED DESCRIPTION

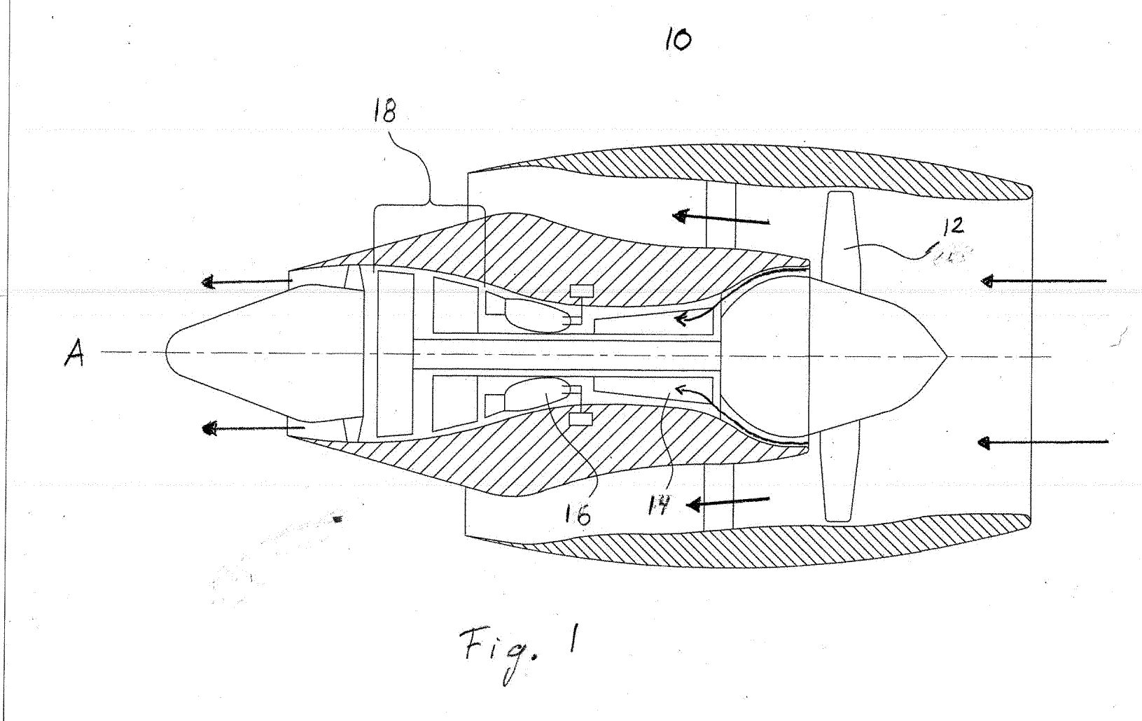

FIG. 1 illustrates, schematically, a gas turbine engine 10 of a type preferably provided for use in an aircraft, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. The air flow direction through the engine, when in operation, is shown schematically in FIG. 1 by arrows. Compressor section 14 is typically comprised of various stages, where the air is sequentially and increasingly pressurized via one or a number of axial and/or centrifugal compressors. As air proceeds through compressor section 14, a certain amount taken/bled; this is known as bleed air.

Bleed air is compressed air, taken/bled from compressor section 14 of an engine when in operation, for purposes other than combustion in the combustor 16. Bleed air is used to provide pressurized air to various parts of an aircraft, such as the environmental control system (ECS), the anti-icing system and various systems of the engine itself, examples of the latter being air used to preserve the stability of the compressor system (known as compressor handling bleed air) or air used to maintain internal engine functions (known as engine secondary air). Each such system has air pressure and/or temperature requirements, which has an effect on where and how bleed air may or may not be taken to satisfy the requirements of each such system.

In engines with a Downstream Centrifugal Impeller, it is well known to take air that will be supplied to the ECS, known as ECS bleed air, at the centrifugal impeller's outlet (i.e. at the outlet of compressor section 14/inlet of the combustor 16, a station known as P3), as this is where ECS bleed air requirements (mass flow, static pressure, temperature . . . ) are met for all engine operation conditions. It is also well known to take ECS bleed air at P3 only when an Engine with a Downstream Centrifugal Impeller is operating in a low pressure range environment (i.e. when operating at low thrust and/or at high altitude, an engine state known as “Low Power”) and to take ECS bleed air more upstream of the P3 station, but still downstream of what is known as the P2 station (which refers to compressor section 14's inlet), when an Engine with a Downstream Centrifugal Impeller is operating in a high pressure range environment (i.e. when operating at higher thrust and/or at lower altitude, an engine state known as “High Power”).

Indeed, when designing bleed air configurations, one must always strive to use as low a supply pressure as possible (i.e. as much upstream compressor section 14 as possible), because the energy that is used by an engine to compress the bleed air is not available for propulsion purposes, with the consequent fuel consumption/efficiency loss. Therefore, a well-known ECS bleed air configuration is such that, as engine operating pressure increases and a predetermined crossover point between the low pressure range and the high pressure range is reached, the ECS bleed air stops being taken from the P3 station and starts being taken more upstream, at stations known as P2.# (with “#” typically being numbers between 0 and 9, 0 referring to a location in the compression section close to its inlet and 9 referring to a location in the compression section close to its outlet); the reverse happens as engine operating pressure decreases. In other words, when an Engine with a Downstream Centrifugal Impeller is at Low Power, (Low Power) ECS bleed air is taken at P3 and, when an Engine with a Downstream Centrifugal Impeller is at High Power, (High Power) ECS bleed air is taken at P2.#.

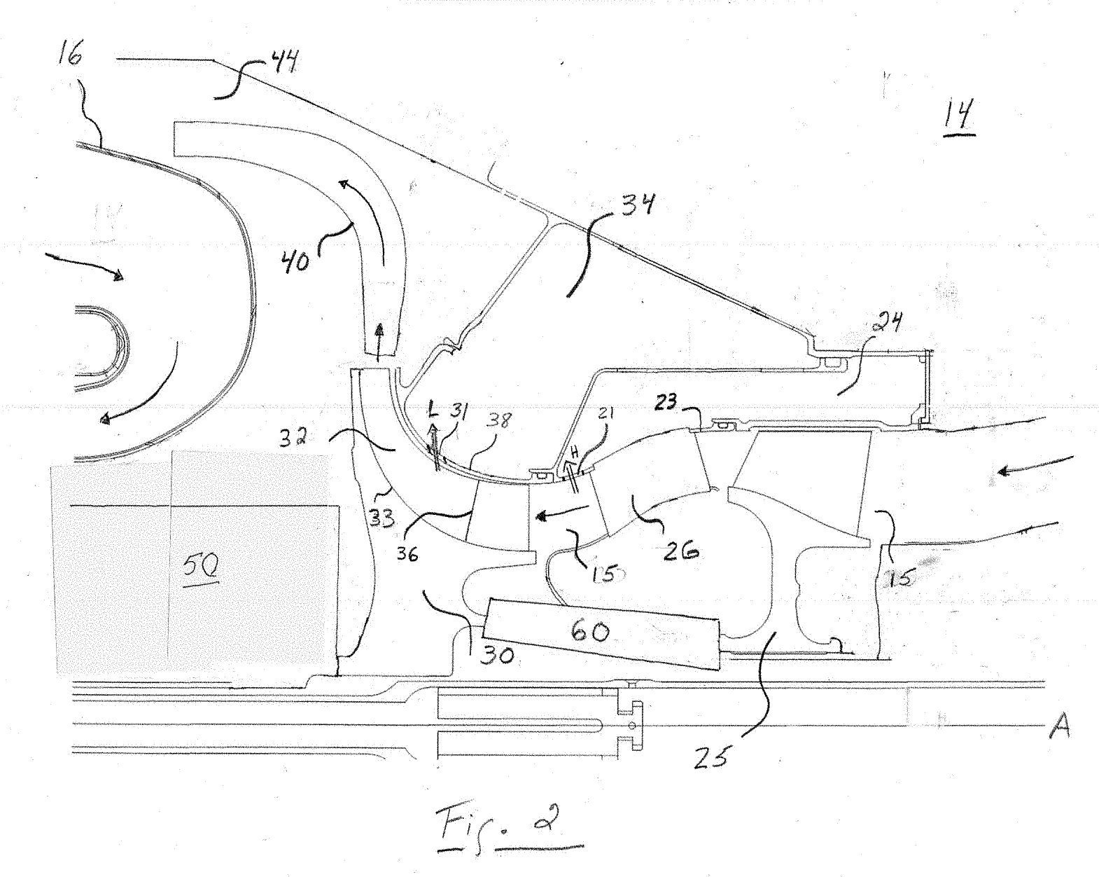

Drawing ECS bleed air at P3 is however problematic as it sometimes contributes to Cabin Fume events (also known as “smoke in the cabin” events or “cabin air contamination” events). Cabin Fume events refer to instances when an aircraft air cabin is contaminated by chemicals. In aircraft powered by Engines with a Downstream Centrifugal Impeller, this sometimes occur because of the compressor shaft bearing cavity's (shown as item 50 in FIG. 2) proximity to the P3 station; indeed, because of such proximity, there is the possibility of the P3 station (and therefore any bleed air being taken therefrom) being contaminated by chemicals such as oil that are present in (but may escape from) such compressor shaft bearing cavity, thereby resulting in a Cabin Fume event. Even though rare, Cabin Fume events are being increasingly frowned upon by airlines. There is therefore a disadvantage in drawing ECS bleed air, in any circumstances, at P3.

Pursuant to an embodiment of the invention, an Engine with a Downstream Centrifugal Impeller will be described, more specifically, as shown in FIG. 2, the downstream part of compressor section 14 and a portion of combustor 16. As represented schematically by single line arrows, air is shown flowing in an annular gas path 15 of compressor section 14 through a penultimate compression stage, in the current embodiment an axial compressor comprising an axial compressor rotor 25 and axial compressor stators 26. The radially outer boundary of the gas path 15 is radial outer wall 23.

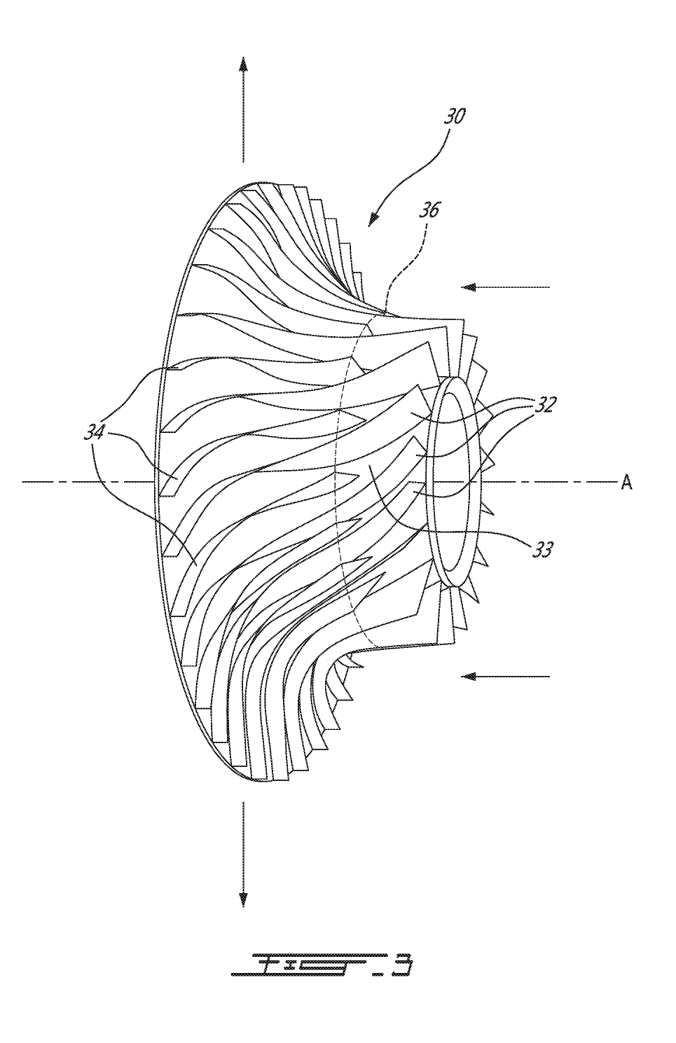

Air thereafter flows through compressor section 14's last compression stage, in the current embodiment centrifugal impeller 30. As is represented schematically by box 60 and is well known in the art, centrifugal impeller 30 is linked to the remaining rotating portion of compressor section 14, such as axial compressor rotor 25 in the current embodiment. As also shown in FIG. 3, centrifugal impeller 30 comprises a hub 33, which acts as the radially inner boundary of the gas path 15, and a plurality of compressor blades 32 protruding within the gas path 15. A stationary centrifugal impeller shroud 38 surrounds compressor blades 32 and acts as the radially outer boundary of the gas path 15. Consequently, air enters centrifugal impeller 30 in a generally axial direction and exits in a generally radial direction (shown schematically with single line arrows in FIG. 3). Centrifugal impeller 30 may also comprise splitter blades 34 which are known to stabilize the air flow exiting centrifugal impeller 30. Such splitter blades 34 are positioned between compressor blades 32 and extend from the exit of the centrifugal impeller 30. The extension of such splitter blades 34 stop short of the entrance of the centrifugal impeller 30 so as to form a plane known as splitter blade leading edge plane 36.

When air exits centrifugal impeller 30, and more generally compression section 14, it enters a diffuser 40, which purpose is to slow down the air flow, more specifically to convert the air flow's pressure from a predominantly dynamic pressure form to a predominantly static pressure form. Air exits diffuser 40 into P3 volute 44. Volute 44 is fluidly linked to combustor 16's entrance, resulting in compressed air from compressor section 14 being fed to combustor 16. P3 Volute 44 is where Low Power ECS bleed air is taken in previously known Engines with a Downstream Centrifugal Impeller. As will be seen in more details below, no ECS bleed air is taken at the P3 station or anywhere downstream centrifugal impeller 30's exit. Therefore, the Cabin Fume event issue outlined above is addressed.

In more recent Engines with a Downstream Centrifugal Impeller, the Overall Compression pressure Ratio (OPR), which is the factor by which compressor section 14 can increase the air pressure (i.e. air pressure at P3/ambient air pressure), is large enough so that the total air pressure at certain points between centrifugal impeller 30's entrance and exit is sufficient to meet current Low Power ECS bleed air requirements. Also, because of more recent aircraft's move towards more electric architectures, ECS bleed air requirements are lower, such that, again, the total air pressure at certain points between centrifugal impeller 30's entrance and exit is sufficient.

As shown in FIG. 2, ECS bleed air (shown schematically by double line arrows) is taken at 2 locations, wherein both locations are positioned on gas path 15's radially outer boundary and positioned upstream of centrifugal impeller 30's outlet, with the 1^{st} location being positioned upstream of the 2^{nd} location.

In Engines with a Downstream Centrifugal Impeller, the location immediately upstream of centrifugal impeller 30 is known as P2.7 and the location over centrifugal impeller 30 (i.e. between the inlet and outlet of this last compression stage), is known as P2.8. In the current embodiment, 1^{st} location is positioned at P2.7, where 1^{st} bleed opening arrangement 21 can be found. High Power ECS bleed air H is taken from the 1^{st} location, more specifically via 1^{st} bleed opening arrangement 21, and directed into P2.7 Volute 24. No further details is given regarding P2.7 Volute 24, or any other volute referred to elsewhere in this description as such details will be apparent to someone skilled in the art.

High Power ECS bleed air H is then taken from P2.7 Volute 24 to the ECS in the way that will be apparent to those skilled in the art (not shown). In the current embodiment, High Power ECS bleed air H is sufficient to meet the compressor handling bleed air and engine bleed air requirements; therefore, air bled at this 1^{st} location is utilised for all three purposes (High Power ECS, compressor handling and engine secondary air system). One skilled in the art will however understand that the invention is not limited to requiring that ECS bleed air taken at the 1^{st} location having to meet all 3 such purposes; other purposes besides, or no purposes save for, High Power ECS system requirements are possible pursuant to the invention. As air pressure exiting axial compressors are generally in the form of static pressure and hence not in need to be significantly converted any further, 1^{st} bleed opening arrangement 21 are orifice(s), through radial outer wall 23, aligned perpendicularly to the air flow direction (similarly to a static pressure tap hole).

In the current embodiment, 2^{nd} location is positioned on centrifugal impeller shroud 38, in the current embodiment at station P2.8, where 2^{nd} bleed opening arrangement 31 can be found. Low Power ECS bleed air L is taken from the 2^{nd} location, more specifically via 2^{nd} bleed opening arrangement 31, and directed into P2.8x Volute 34.

Low Power ECS bleed air L is then taken from P2.8x Volute 34 to the ECS in the way that will be apparent to those skilled in the art (not shown). In the current embodiment, Low Power ECS bleed air L is sufficient to meet the aircraft anti-icing system bleed air requirements; therefore, air bled at this 2^{nd} location is utilised for both purposes (Low Power ECS and anti-icing system). One skilled in the art will however understand that the invention is not limited to requiring that ECS bleed air taken at the 2^{nd} location having to meet both purposes; other purposes besides, or no purposes save for, Low Power ECS system requirements are possible pursuant to the invention.

The air passing through centrifugal impeller 30, more specifically the air flowing over centrifugal impeller shroud 38, fluctuates in terms of its characteristics, such as total pressure, ratio of dynamic vs static pressure, turbulence etc. . . . . The choice of the 2^{nd} location, more specifically the location of 2^{nd} bleed opening arrangement 31, as well as the characteristics of such 2^{nd} bleed opening arrangement 31, will therefore depend on such characteristics. The 2^{nd} location must be positioned, along centrifugal impeller shroud 38, where sufficient total energy (air pressure) is available to meet current Low Power ECS bleed air requirements and 2^{nd} bleed opening arrangement 31 must have enough dynamic energy (pressure) recovery characteristics to ensure the necessary dynamic to static energy (pressure) conversion. Indeed, the dynamic energy (i.e. pressure) of air flowing through a centrifugal impeller represents a large proportion of the total energy (i.e. pressure) of such flow. As only the static energy (i.e. pressure) is useful for bleed air purposes, one must ensure, when taking bleed air from a passing air flow, that the static energy (pressure) is high enough to meet the bleed requirements, and/or to sufficiently convert dynamic energy (pressure) into static energy (pressure) to meet such requirements. Pursuant to the invention, this means that, when adding the static pressure at the 2^{nd} location plus the dynamic recovery characteristics of the 2^{nd} bleed opening arrangement 31, the Low Power ECS bleed air requirements are met. As one travels upstream along centrifugal impeller shroud 38 and the static pressure increases, this means that the dynamic recovery needs of the 2^{nd} bleed opening arrangement 31 decrease

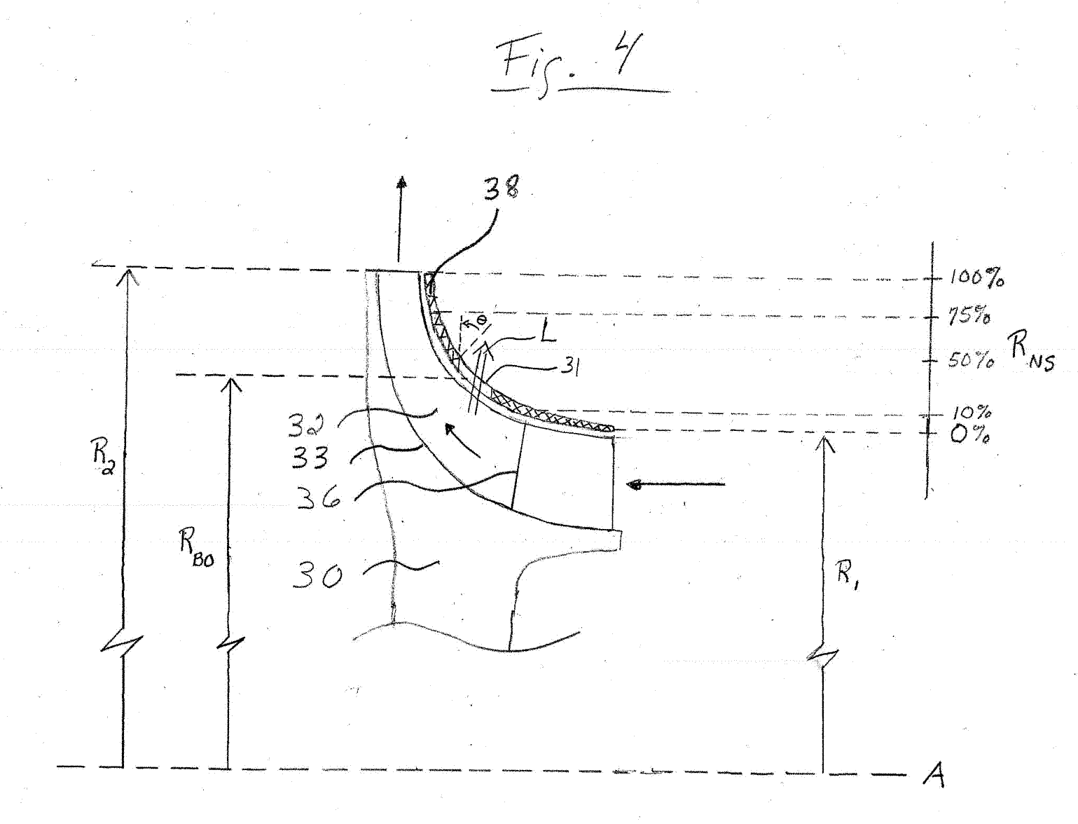

A shown in FIG. 4, the position of 2^{nd} location, more specifically the position of 2^{nd} bleed opening arrangement 31, is expressed in terms of normalised shroud radial position R_{NS}.

wherein

$$RNS = \frac{RBO - R 1}{R 2 - R 1} * 100$$

with R₁: radial distance of shroud 38, at the entrance of centrifugal impeller 30
R₂: radial distance of shroud 38, at the exit of centrifugal impeller 30
R_{BO}: radial distance of 2^{nd} bleed opening arrangement 31

all radial distances being from engine centerline A.

A 100% R_{NS} position would mean that 2^{nd} bleed opening arrangement 31 would be positioned at centrifugal impeller 30's exit. As outlined above, no ECS bleed air is to be taken at the P3 station or anywhere downstream centrifugal impeller 30's exit (to address Cabin Fume event issues). In order to add a certain margin of safety in that regard (i.e. to avoid taking P3 air), it is preferred to avoid taking ECS bleed air in the immediate upstream vicinity of centrifugal impeller 30's exit. Furthermore, taking ECS bleed air in the immediate upstream vicinity of centrifugal impeller 30's exit could raise some tip impeller to shroud clearance issues. More specifically, having bleed opening arrangements and/or dynamic pressure recovery mechanisms near the shroud's exit could affect such shroud tip's stiffness, with a negative impact on the impeller-shroud clearance at that location. Shroud stiffness design is contingent upon anticipated impeller and shroud displacement during operation. Consequently, it has been found to be preferred to have 2^{nd} bleed opening arrangement 31 positioned upstream of the 75% R_{NS} position.

A 0% R_{NS} position would mean that 2^{nd} bleed opening arrangement 31 would be positioned at centrifugal impeller 30's entrance. That position, or in its immediate downstream vicinity, would not be preferred because of the insufficient pressure rise in the air. Furthermore, at least until a point downstream of splitter blade leading edge plane 36, air flow would present stability issues. Consequently, it has been found to be preferred to have 2^{nd} bleed opening arrangement 31 positioned downstream of the splitter blade leading edge plane 36 or, alternatively, downstream of the 10% R_{NS} position. In the embodiment shown in FIG. 4, 2^{nd} bleed opening arrangement 31 is positioned at approximately the 50% R_{NS} position

Turning now to the characteristics of 2^{nd} bleed opening arrangement 31, it is understood the more upstream it is positioned, the greater the dynamic pressure recovery will be needed. This is because, as one travels upstream on centrifugal impeller shroud 38, the lower the available static pressure of the air is. In the embodiment shown in FIG. 4, the dynamic pressure recovery characteristics of 2^{nd} bleed opening arrangement 31 consists in having orifice(s), through centrifugal impeller shroud 38, aligned partially tangential to the air flow direction i.e. at an angle θ (as shown in FIG. 4) from a position away from a perpendicular to the air flow direction (i.e. away from a static pressure tap hole configuration). As one would move 2^{nd} bleed opening arrangement 31 downstream of the approximate 50% R_{NS} position, less dynamic pressure recovery characteristics would be need, which could translate in 2^{nd} bleed opening arrangement 31 consists in having orifice(s), through centrifugal impeller shroud 38, aligned less tangentially to the air flow direction (i.e. at a lesser angle θ). On the other hand, as one would move 2^{nd} bleed opening arrangement 31 upstream of the approximate 50% R_{NS} position, more dynamic pressure recovery characteristics would be need, which could translate in 2^{nd} bleed opening arrangement 31 consists in having orifice(s), going through centrifugal impeller shroud 38, aligned more tangentially to the air flow direction (i.e. at a larger angle θ) and/or introducing other dynamic pressure recovery mechanisms such as local vane diffuser, pipe diffuser or swirl break.

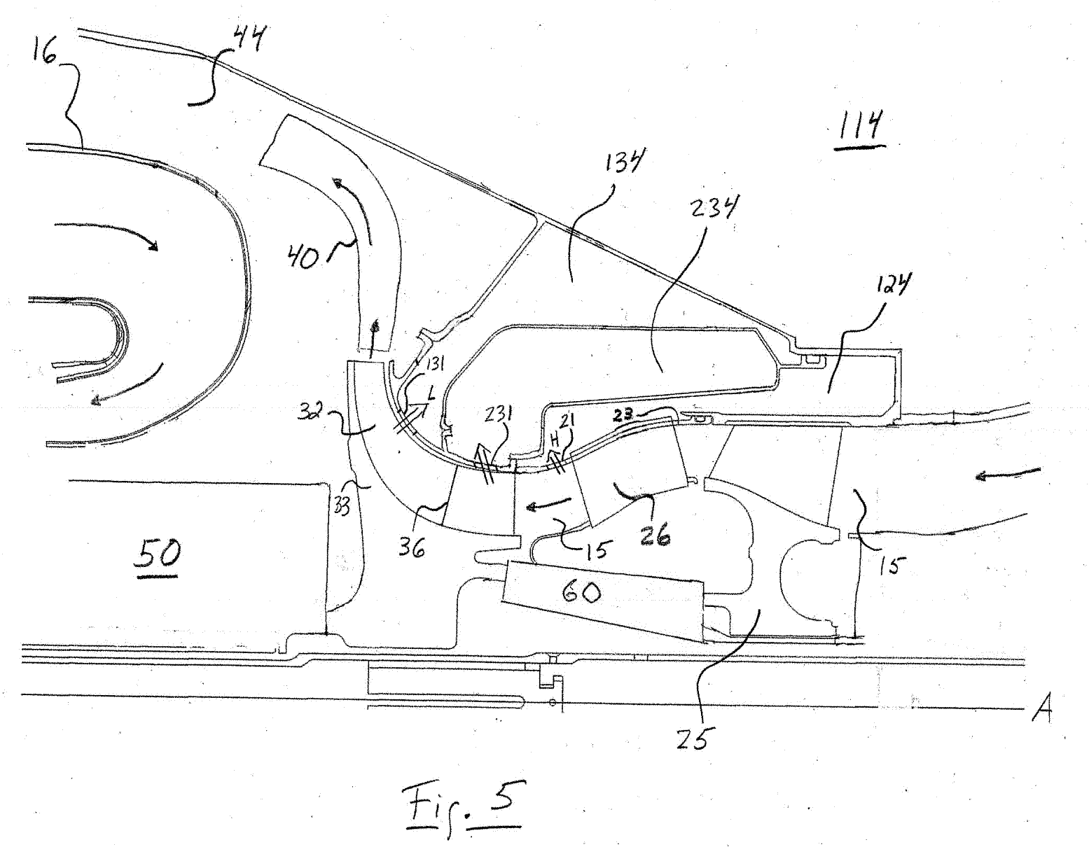

FIG. 5 shows the downstream part of compressor section 114 pursuant to an alternate embodiment of the invention and a portion of combustor 16. In this alternate embodiment, bleed air is taken at 3 locations (as opposed to 2 locations in the above-described, and shown in FIG. 4, embodiment). More specifically, a further bleed air location is added on centrifugal impeller shroud 38.

In the embodiment shown in FIG. 5, High Power ECS bleed air H is taken at a 1^{st} location, more specifically from 1^{st} bleed opening arrangement 21 and directed into P2.7 Volute 124. However, contrary to compressor section 14 shown in FIG. 4, the only other purpose met by the P2.7 Volute 124 air is engine secondary air system, with compressor handling purpose being met at another bleed location.

Low Power ECS bleed air L is taken at a 2^{nd} location, more specifically from 2^{nd} bleed opening arrangement 131, which is positioned more downstream of 2^{nd} bleed opening arrangement 31 described in FIG. 4, and directed into P2.8x Volute 134. Because of such further downstream location, 2^{nd} bleed opening arrangement 131 has lesser dynamic pressure recovery needs than 2^{nd} bleed opening arrangement 31 described in FIG. 4. Consequently, as shown in FIG. 5, 2^{nd} bleed opening arrangement 131 consists in having orifice(s) going through centrifugal impeller shroud 38 at a lesser angle than what was present in 2^{nd} bleed opening arrangement 31. In the current embodiment, air bled at this 2^{nd} location is again also utilised for anti-icing system purposes.

A 3^{rd} bleed air location, positioned on centrifugal impeller shroud 38 and upstream of 2^{nd} location, is utilised for compressor handling bleed air purposes. This is where 3^{rd} bleed opening arrangement 231 can be found. One skilled in the art will recognise that 3^{rd} bleed opening arrangement 231 is positioned upstream of splitter blade leading edge plane 36, with the consequent air flow turbulence and lower total pressure issues that arise therefrom; the characteristics of 3^{rd} bleed opening arrangement 231 will be consequently adjusted to meet such compressor handling bleed air purposes.

The above description is meant to be exemplary only, and one skilled in the art will recognize that changes may be made to the embodiments described without departing from the scope of the invention disclosed. For example, in the embodiment outlined above, a number of axial compressors are found upstream of centrifugal impeller 30. One, or no, axial compressor may be found (for example in Engines with a Downstream Centrifugal Impeller where centrifugal impeller 30 provides all of the necessary air compression). Alternatively, other types of compressors, such as one or more centrifugal impellers, may be found upstream of centrifugal impeller 30. Furthermore, other bleed opening arrangements, over and above the 2 ECS bleed air opening arrangements, may be found pursuant to the invention. Still other modifications which fall within the scope of the present invention will be apparent to those skilled in the art, in light of a review of this disclosure, and such modifications are intended to fall within the appended claims.

1. A method of bleeding air from a gas turbine engine having a compressor section with a downstream centrifugal compressor, the method comprising:
when the compressor is operating in a first pressure range, bleeding air from a first location positioned upstream of the centrifugal compressor's outlet; and
when the engine is operating in a second pressure range, the second pressure range being lower than the first pressure range, bleeding air from a second location positioned upstream of the centrifugal compressor's outlet, the second location being positioned downstream of the first location.

2. The method, as defined in claim 1, wherein the method supplies air to an environmental control system of an aircraft.

3. The method, as defined in claim 1, wherein the second location is positioned downstream of the centrifugal compressor's inlet.

4. The method, as defined in claim 3, wherein the first location is positioned upstream of the centrifugal compressor's inlet.

5. The method, as defined in claim 3, wherein the centrifugal compressor comprises splitter blades and the second location is positioned downstream of the splitter blades' leading edge.

6. The method, as defined in claim 3, wherein the second location is positioned between 10% and 75% normalised shroud radial position.

7. The method, as defined in claim 3, wherein bleeding air from the second location comprises partially recovering dynamic pressure of the air.

8. The method, as defined in claim 5, wherein bleeding air from the second location comprises partially recovering dynamic pressure of the air.

9. The method, as defined in claim 6, wherein bleeding air from the second location comprises partially recovering dynamic pressure of the air.

10. The method, as defined in claim 1, wherein the second location is positioned on the centrifugal compressor's shroud.

11. A compressor section of a gas turbine engine for providing compressed air to a combustor, the compressor section comprising:
an annular gas path, positioned around the engine's centerline, for conveying air across the compressor section;
a centrifugal impeller, positioned in the compressor section's downstream extremity, the centrifugal impeller comprising a plurality of blades protruding within the annular gas path, wherein air enters an inlet of the centrifugal impeller in a generally axial direction and exits an outlet of the centrifugal impeller in a generally radial direction;
an impeller shroud surrounding the blades and a radial outer wall of the annular gas path disposed upstream of the impeller shroud, the impeller shroud and the radial outer wall being joined to together form a portion of the annular gas path's radially outer boundary;
a first bleed opening arrangement, for bleeding air from the annular gas path when the engine is operating in a first pressure range; and
a second bleed opening arrangement, positioned in the impeller shroud, for bleeding air from the annular gas path when the engine is operating in a second pressure range, the second pressure range being lower than the first pressure range.

12. The compressor section as defined in claim 11, wherein the first and second bleed opening arrangements provide bleed air to an environmental control system of an aircraft.

13. The compressor section as defined in claim 11, wherein the second bleed opening arrangement is capable of partially recovering the air's dynamic pressure.

14. The compressor section as defined in claim 11, wherein the centrifugal impeller comprises splitter blades and the second bleed opening arrangement is positioned downstream of the splitter blades' leading edge.

15. The compressor section as defined in claim 11, wherein the second bleed opening arrangement is positioned between 10% and 75% normalised shroud radial position.

16. The compressor section as defined in claim 14, wherein the second bleed opening arrangement comprises orifices, through the impeller shroud, aligned partially tangential to the compressed air flow direction.

17. The compressor section as defined in claim 15, wherein the second bleed opening arrangement comprises orifices, through the impeller shroud, aligned partially tangential to the compressed air flow direction.

18. The compressor section as defined in claim 11, further comprising a third bleed opening arrangement, positioned in the impeller shroud, for providing bleed air to the engine.

19.-20. (canceled)

21. The compressor section as defined in claim 1, wherein the first bleed arrangement is positioned in the radial outer wall upstream of the inlet of the centrifugal impeller.

22. The compressor section as defined in claim 1, wherein the second bleed opening arrangement is positioned in the impeller shroud upstream of the outlet of the centrifugal impeller and downstream of the inlet of the centrifugal impeller.
